(19) United States
(12) Patent Application Publication
(10) Pub. No.: US 2007/0184882 A1
(43) Pub. Date: Aug. 9, 2007

(54) Portable communication terminal for games

(75) Inventor: Young S. Kim, Los Altos, CA (US)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/651,820

(22) Filed: Jan. 10, 2007

Related U.S. Application Data
(60) Provisional application No. 60/758,258, filed on Jan. 10, 2006.

(30) Foreign Application Priority Data
Aug. 3, 2006 (KR) 2006-73381

(51) Int. Cl. H04B 1/38; H04M 1/00

(52) U.S. Cl. 455/575.4; 455/90.3

(57) ABSTRACT

Provided is a portable communication terminal that is convenient for use in a game mode. The portable communication terminal includes a main body housing including at least one key, a sliding housing including a display unit, sliding perpendicularly to the longitudinal direction of the main body housing while facing the main body housing to open or close a predetermined area of the top of the main body housing and being stood inclined on the main body housing after sliding, and at least one speaker device mounted in a lateral side of the main body housing to emanate sounds directly to a user.

### PRIORITY

This application claims priority under 35 U.S.C. § 119 to a provisional patent application entitled “Portable Communication Terminal for Games” filed in the United States Patent and Trademark Office on Jan. 10, 2006 and assigned Ser. No. 60/758,258 and under 35 U.S.C. § 119 to a patent application entitled “Portable Communication Terminal for Games” filed in the Korean Intellectual Property Office on Aug. 3, 2006 and assigned Serial No. 2006-73381, the contents of which are incorporated herein by reference.

### BACKGROUND OF THE INVENTION

1. Field of the Invention

The present invention generally relates to, and in particular, to a portable communication terminal such as a Digital Multimedia Broadcasting (DMB) phone, a game phone, a chatting phone, a camera phone, a Moving Picture Experts Group (MPEG) Layer-3 (MP3) phone, a cellular phone, a Personal Communication Service (PCS) phone, a Personal Digital Assistant (PDA), and a Hand Held Phone (HHP), and in particular, to a portable communication terminal for games, which is easy to use in a game mode or a DMB mode, as well as in a phone mode.

2. Description of the Related Art

Generally, the term “portable communication terminal” refers to an electronic apparatus which a user can carry with him/her to perform wireless communication with a desired partner. The wireless communication may include voice communication, message transmission, file transmission, video communication, and a camera function. Additionally, the portable communication terminal serves as a personal agent by performing phone number management and personal schedule management.

In consideration of portability, designs of the portable communication terminal tend to be compact, slim, and light, and also include multimedia availability for a wide variety of service functions, e.g., entertainment functions including game services. In particular, future portable communication terminals are expected to incorporate greater multi-functionality and multi-purpose utilization including video communication, game, Internet, and camera functions, as well as a voice communication function.

Conventional portable communication terminals may be classified into various types according to their appearance in consideration of portability and convenience in use, such as bar-type portable communication terminals and folder-type portable communication terminals. The bar-type portable communication terminal has a single housing shaped like a bar in which data input/output devices, an antenna device, and transmission/reception devices are mounted. The folder-type portable communication terminal has a folder coupled to a single bar-shaped housing by a hinge device in such a manner that the folder can be rotated in order to be folded towards and unfolded away from the housing. A folder is rotatably coupled to a main body by a hinge unit, keys are disposed in the main body, and a display unit is disposed in the folder in the folder-type portable communication terminal, contributing to miniaturization and portability. The folder-type portable communication terminal is disclosed in U.S. Pat. No. 6,865,406 granted to the assignee of the present application. In the disclosed folder-type portable communication terminal, a camera lens housing is mounted in a hinge unit.

Additionally, the portable communication terminals may be further classified as swing-type communication terminals and sliding-type communication terminals based upon the way of opening and closing the communication terminals. In the swing-type portable communication terminals, two housings are coupled to each other to allow one housing to rotate open or closed relative to the other while facing each other. In the sliding-type portable communication terminal, two housings are coupled to each other to allow one housing to slide along a longitudinal direction to open or close the sliding-type portable communication terminal.

For example, in the sliding-type portable communication terminal, a main body and a slider are coupled to each other by a sliding module while facing each other, a plurality of keys are disposed in the main body, and a display unit is disposed in the slider. Such a structure is advantageous to a wide display unit and provides for ease in opening/closing operations. The sliding-type portable communication terminal is disclosed in detail in Korean Patent No. 2002-71911. In the sliding-type portable communication terminal, a plurality of keys are disposed in a main body housing and a display unit is mounted in a sliding housing. The swing-type portable communication terminal is disclosed in detail in U.S. patent application Ser. No. 10/822,380.

In the conventional folder-type portable communication terminal, the user is not inconvenienced in a data input operation and a displayed data check operation in a phone mode like voice communication or text message transmission. However, in multimedia environments, the promptness or accuracy of a data input operation such as key pressing suffers in a game mode and a wide screen cannot be provided in a display unit. The promptness and accuracy of key manipulation are more important in the game mode than in any other mode. In particular, key manipulation using both hands instead of one hand is crucial for improving promptness and accuracy.

Of course, the foregoing problems can be solved by increasing the size of the portable communication terminal, mounting a wide display unit in the portable communication terminal, and disposing a greater number of keys in the portable communication terminal, which goes against miniaturization and causes inconvenience in carrying.

The sliding-type portable communication terminal can be easily opened and closed and provides a wide display unit. In the sliding-type portable communication terminal like in the folder-type portable communication terminal, although problems are not caused in the phone mode, the user feels inconvenience in key manipulation in the game mode and broadcasting watching in a Digital Multimedia Broadcasting (DMB) mode.

Therefore, there is a need for a portable communication terminal that is used as a convenient sliding type in the phone mode, facilitates key manipulation with both hands in the game mode, and provides a wide display unit stood inclined in the DMB mode.

### SUMMARY OF THE INVENTION

It is, therefore, an object of the present invention to provide a portable communication terminal that allows a user to conveniently watch broadcasting in a DMB mode.

It is another object of the present invention to provide a portable communication terminal, in which a display unit in a landscape view mode may be inclined and stereo sounds emanate directly to a user in the line direction of the display unit, thereby improving the quality of watching broadcasting.

It is further another object of the present invention to provide a portable communication terminal, in which keys include a microphone device and a speaker device therein, thereby improving the efficiency of a mounting space.

To achieve the above and other objects, there is provided a portable communication terminal including a main body housing, a sliding housing, and one or more speaker devices. The main body housing includes one or more keys. The sliding housing includes a display unit, can slide perpendicularly to the longitudinal direction of the main body housing while facing the main body housing to open or close a predetermined area of the top of the main body housing, and can stand inclined on the main body housing after sliding. The speaker devices are mounted in a lateral side of the main body housing to emanate sounds directly to a user.

According to another aspect of the present invention, there is provided a data input device, a data output device, and a stereo speaker device. The data output device includes a display unit, can slide perpendicularly to the longitudinal direction of the data input device while facing the data input device to open or close a predetermined area of the top of the data input device, and can stand inclined on the data input device after sliding. The stereo speaker device is mounted in a lateral side of the data input device to emanate sounds directly to a user.

### BRIEF DESCRIPTION OF THE DRAWINGS

The above and other objects, features and advantages of the present invention will become more apparent from the following detailed description when taken in conjunction with the accompanying drawings in which:

FIG. 1 is a perspective top view of a portable communication terminal for games according to the present invention;

FIG. 2 is a perspective bottom view of the portable communication terminal of FIG. 1;

FIG. 3 is a perspective top view of a portable communication terminal in which a sliding housing according to the present invention slides open; and

FIG. 4 is a perspective top view of a portable communication terminal in which a sliding unit according to the present invention stands inclined after sliding open.

### DETAILED DESCRIPTION OF THE PREFERRED EMBODIMENT

A preferred embodiment of the present invention will now be described in detail with reference to the annexed drawings. In the following description, a detailed description of known functions and configurations incorporated herein has been omitted for conciseness.

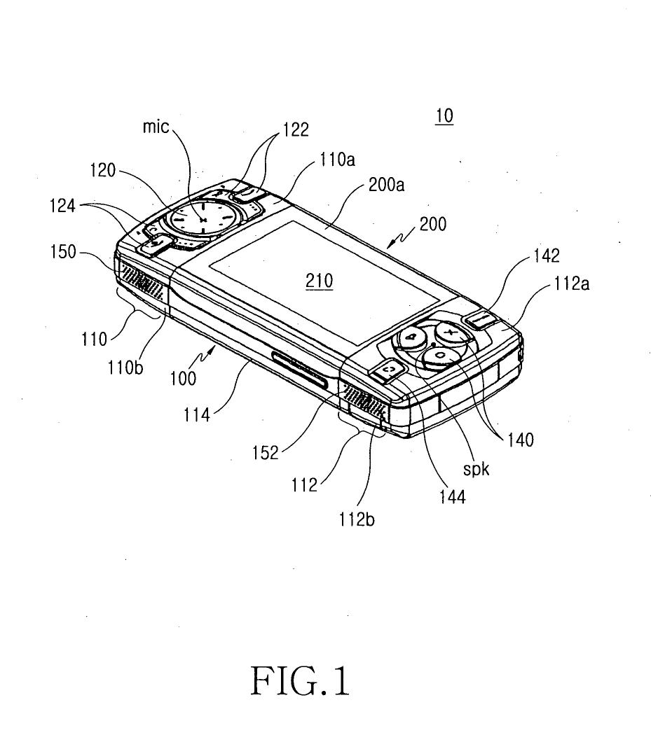

As shown in FIGS. 1 through 4, a portable communication terminal 10 according to the present invention includes a main body housing 100 having a data input device and a sliding housing 200 having a display unit 210. More specifically, the sliding housing 200 slides perpendicularly to the longitudinal direction of the main body housing 100 while facing the main body housing 100 in order to open or close a predetermined area of the top of the main body housing 100 and rotates on the main body housing 100 after sliding open in order to be inclined. One or more speaker devices 150 and 152 are installed in the lateral side of the main body housing 100 to emanate sounds directly to a user in the line direction of the main body housing 100.

The main body housing 100 includes a left portion 110, a right portion 112, and a central portion 114. The central portion 114 is recessed to a predetermined depth between the left portion 110 and the right portion 112 to provide a space to receive the slide housing 200. A plurality of keys that recognize data through user's pressing are disposed on the top of the main body housing 100. The keys include first keys 120, 122 and 124 that are disposed on a top face 110a of the left portion 110 for being exposed at all times, second keys 140, 142, and 144 that are disposed on a top face 112a of the right portion 112 for being exposed at all times, and third keys 130, 132, and 134 that are disposed on a top face 114a of the central portion 114 for being exposed or hidden according to sliding of the slide housing 200.

The first keys include a multi-directional key 120 having a microphone “mic” at its center. The second keys include game action keys 140 having a single speaker device “spk” therein. The microphone device “mic” and the speaker device “spk” are mounted in the center portion of the multi-directional key 120 and the game action keys 140 respectively, thereby optimizing a mounting space. The third keys include 3×4 keys 130.

The speaker devices 150 and 152 include a first speaker device 150 mounted in a line face 110b of the left portion 110 and a second speaker device 152 mounted in a line face 112b of the right portion 112. The first speaker device 150 and the second speaker device 152 provide stereo sounds directly to the user, thereby improving the quality of listening during watching of moving pictures.

On the top of the slide housing 200, only the display unit 210 is mounted. Preferably, the display unit 210 is implemented with a Liquid Crystal Display (LCD) or a touch screen.

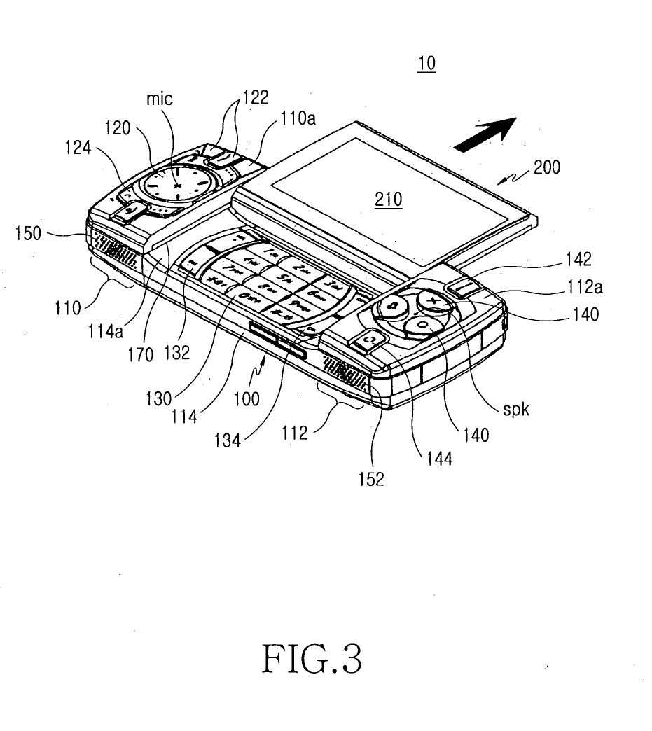

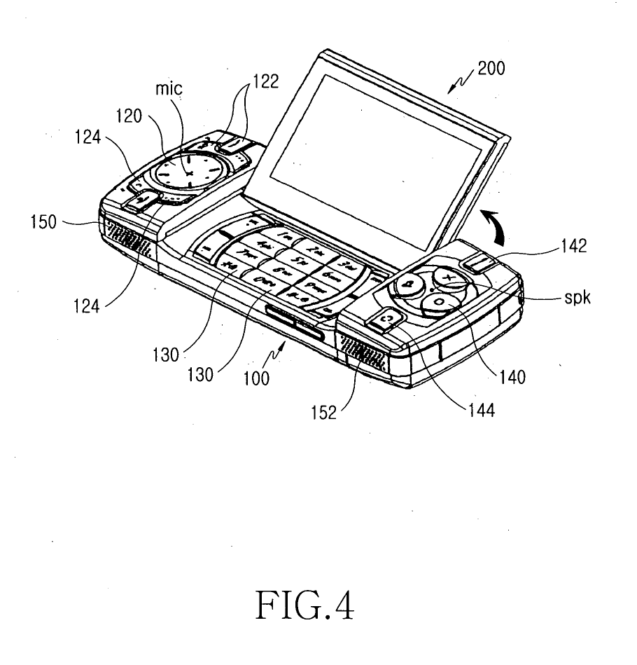

As shown in FIG. 3, the sliding housing 200 moves on the central portion 114 perpendicularly to the longitudinal direction of the main body housing 100 while facing the main body housing 100. After sliding, the sliding housing 200 rotates relative to a predetermined axis to be inclined on the central portion 114. FIG. 3 shows a state in which the slide housing 200 completely slides and FIG. 4 shows a state in which the sliding housing 200 is inclined. Guide rails 170 are provided in the inner walls of both sides of the central portion 114 to guide movement of the slide housing 200. In FIGS. 3 and 4, only one guide rail 170 is shown. A slide standing device (not shown) is mounted between the rear portion of the central portion 114 and the bottom of the slide housing 200. The slide housing 200 slides by the slide standing device as shown in FIG. 3 and rotates to be inclined on the main body housing 100 as shown in FIG. 4.

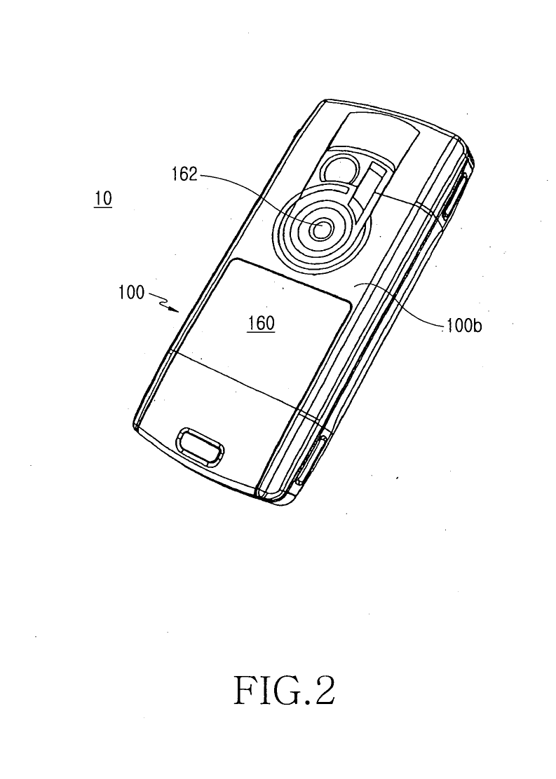

The states as shown in FIGS. 1 and 2 are convenient for use in a phone mode or a text transmission mode and the state shown in FIG. 4 is convenient for use in a DMB mode for watching various moving pictures. This is because the display unit 210 in a landscape view mode stands inclined and the first speaker device 150 and the second speaker device 152 emanate stereo sounds in the line direction of the main body housing 100.

As shown in FIG. 2, a battery pack 160 and a camera lens 162 are disposed on a bottom face 100b of the main body housing 100.

As described above, a portable communication terminal according to the present invention is convenient for use in a game mode or a DMB mode as well as in a phone mode. In particular, a display unit in a landscape view mode is inclined and stereo sounds emanate directly to a user in the line direction of the display unit, thereby facilitating and improving watching of broadcasting. Furthermore, keys include a microphone device and a speaker device therein, thereby improving the efficiency of a mounting space.

While the invention has been shown and described with reference to a certain preferred embodiment thereof, it will be understood by those skilled in the art that various changes in form and details may be made therein without departing from the spirit and scope of the invention.

What is claimed is:

1. A portable communication terminal comprising:
a main body housing including at least one keys;
a slide housing including a display unit slidably and rotatably connected to the main body housing, wherein the slide housing slides perpendicularly to a longitudinal direction of the main body housing while facing the main body housing to open or close a predetermined area of a top of the main body housing, and can be inclined on the main body housing after sliding; and
at least one speaker device mounted in a lateral side of the main body housing to emanate sounds directly to a user.

2. The portable communication terminal of claim 1, wherein the main body housing comprises:
a left portion;
a right portion; and
a central portion being recessed between the left portion and the right portion to a predetermined depth to receive the slide housing,
wherein the at least one speaker device comprises:
a first speaker device mounted in a line face of the left portion; and
a second speaker device mounted in a line face of the right portion.

3. The portable communication terminal of claim 2, wherein the main body housing further comprises:
first keys disposed on a top of the left portion for being exposed at all times;
second keys disposed on a top of the right portion for being exposed at all times; and
third keys disposed on a top of the central portion for being exposed or hidden according to sliding of the slide housing.

4. The portable communication terminal of claim 3, wherein the first keys include a multi-directional key having a microphone device at a center of the multi-directional key.

5. The portable communication terminal of claim 3, wherein the second keys include a game action key having a single speaker device at a center of the game action key.

6. The portable communication terminal of claim 2, further comprising guide means in inner walls on both sides of the central portion.

7. A portable communication terminal comprising:
a data input device;
a data output device slidably and rotatably connected to the data input device, wherein the data output device slides perpendicularly to a longitudinal direction of the data input device while facing the data input device to open or close a predetermined area of the data input device, and can be inclined on the data input device after sliding; and
a stereo speaker device mounted in a lateral side of the data input device to emanate sounds directly to a user.

8. The portable communication terminal of claim 7, wherein the data input device includes a microphone device and a single speaker device.
